(19) United States
(12) Patent Application Publication
(10) Pub. No.: US 2024/0143544 A1
(43) Pub. Date: May 2, 2024

(54) SYNCHRONIZING HOST MOVEMENT TO HCI SATELLITE NODES

(71) Applicant: Dell Products L.P., Round Rock, TX (US)

(72) Inventors: Jason YE, Suzhou City (CN); Donald MACE, Mashpee, MA (US); Tianming ZHANG, Brighton, MA (US); Carl SHI, Shanghai (CN); Brook Quan ZHANG, Shanghai (CN)

(73) Assignee: Dell Products L.P., Round Rock, TX (US)

(21) Appl. No.: 17/975,065

(22) Filed: Oct. 27, 2022

(51) Int. Cl. G06F 16/11; G06F 16/178

(52) U.S. Cl. CPC G06F 16/122; G06F 16/178

(57) ABSTRACT

An information handling system may include at least one processor and a memory. The information handling system may be configured to maintain a plurality of folders in a central management system, wherein each folder is a data structure having one or more hosts associated therewith; and in response to an instruction to move a particular host from a first folder to a second folder: un-associate the particular host from the first folder; associate the particular host with the second folder; and transmit a notification regarding the movement to a local management system of a satellite information handling system; wherein the local management system is configured to update a local data structure regarding the movement.

### TECHNICAL FIELD

The present disclosure relates in general to information handling systems, and more particularly to techniques for synchronizing changes in a cluster environment such as a hyper-converged infrastructure (HCI) cluster.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on a cluster of standard, off-the-shelf servers referred to as nodes or hosts. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems are used for edge computing scenarios, where satellite nodes are deployed in enterprise network edge locations. For example, one central HCI management system (e.g., vCenter) may support multiple HCI clusters at edge locations. Each edge HCI cluster may include a local HCI management system (e.g., VxRail Manager) in communication with the central HCI management system.

The central HCI management system may leverage a “folder” paradigm in some implementations. Folders may be a data structure used to group objects (typically objects of the same type, such as a folder of HCI hosts or a folder of VMs) for easier management. A common set of permissions and/or metadata may then be applied to the folder, and these permissions and/or metadata may then automatically apply to all objects grouped in the folder. For example, membership in a folder can determine how specific actions are applied to a host (e.g., how often updates are applied). If a host moves from one folder to another, the HCI management system should keep track of what settings should be applied to it.

A folder may also contain one or more other folders in some situations. For example, a first folder might contain both a set of VMs and a second folder, with the second folder containing a different set of VMs.

Folders may also be used in the context of lifecycle management (LCM) tasks, which generally refers to the application of software and/or firmware updates to an HCI cluster. Each satellite node may be placed under a single managed host folder (e.g., a folder associated with a particular edge datacenter or a particular HCI cluster), and it can be moved from one folder to another by a user if needed. As such, the HCI management system may need to synchronize the node folder movement events from a central HCI management system to the local HCI management system of the edge clusters in order to perform folder-based node management correctly.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with synchronizing changes in an HCI environment may be reduced or eliminated.

In accordance with embodiments of the present disclosure, an information handling system may include at least one processor and a memory. The information handling system may be configured to maintain a plurality of folders in a central management system, wherein each folder is a data structure having one or more hosts associated therewith; and in response to an instruction to move a particular host from a first folder to a second folder: un-associate the particular host from the first folder; associate the particular host with the second folder; and transmit a notification regarding the movement to a local management system of a satellite information handling system; wherein the local management system is configured to update a local data structure regarding the movement.

In accordance with these and other embodiments of the present disclosure, a method may include an information handling system maintaining a plurality of folders in a central management system, wherein each folder is a data structure having one or more hosts associated therewith; and in response to an instruction to move a particular host from a first folder to a second folder, the information handling system: un-associating the particular host from the first folder; associating the particular host with the second folder; and transmitting a notification regarding the movement to a local management system of a satellite information handling system; wherein the local management system is configured to update a local data structure regarding the movement.

In accordance with these and other embodiments of the present disclosure, an article of manufacture may include a non-transitory, computer-readable medium having computer-executable instructions thereon that are executable by a processor of an information handling system for: maintaining a plurality of folders in a central management system, wherein each folder is a data structure having one or more hosts associated therewith; and in response to an instruction to move a particular host from a first folder to a second folder: un-associating the particular host from the first folder; associating the particular host with the second folder; and transmitting a notification regarding the movement to a local management system of a satellite information handling system; wherein the local management system is configured to update a local data structure regarding the movement.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

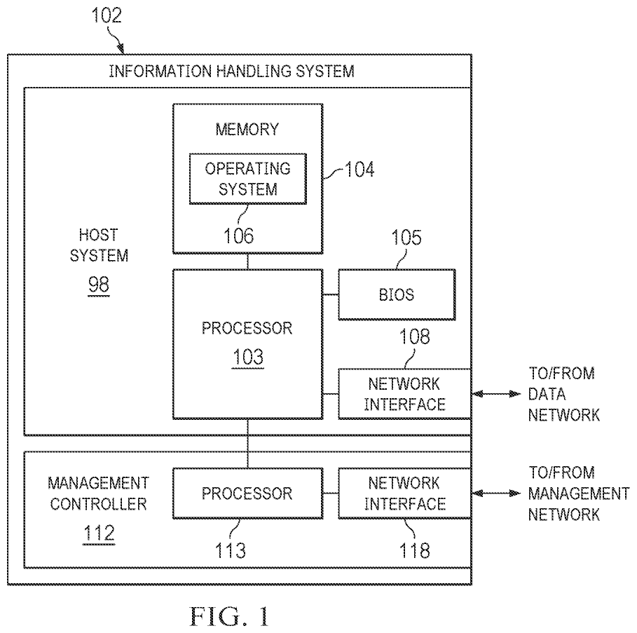

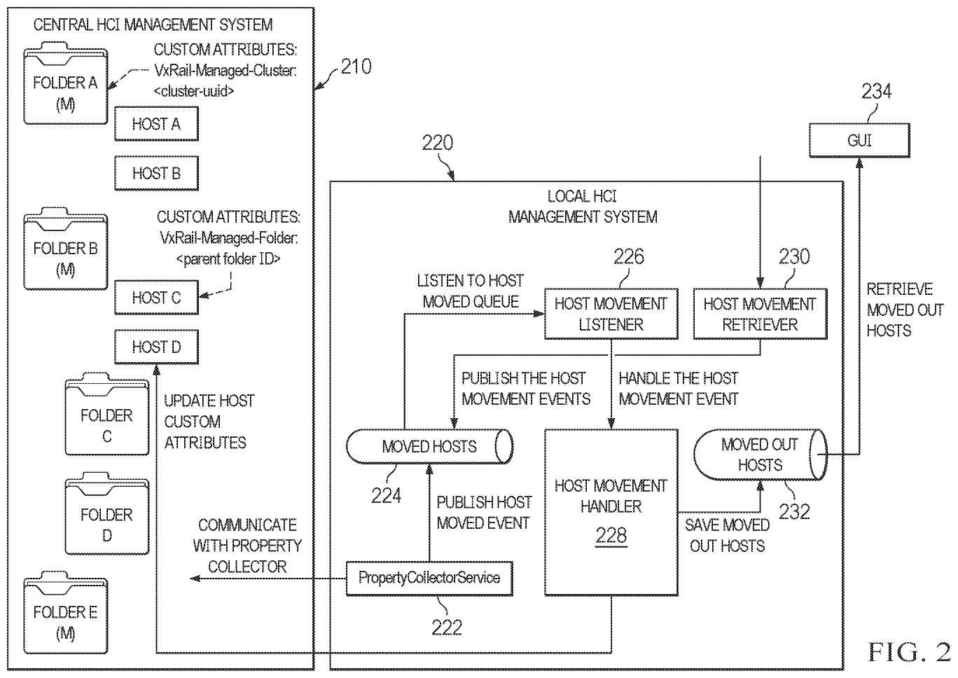

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide improvements in the field of synchronizing folder movement events between a central HCI management system and its satellite nodes. In one embodiment, the HCI management system may implement event-based automatic folder updates for managed satellite nodes, which may automatically update folder information immediately after receiving a related event. Additionally, the HCI management system may expose a full synchronization trigger option to the user, allowing the user to perform a manual synchronization of the satellite node folder information at any time as needed. The manual synchronization is typically used to handle corner cases that may cause event handling to be missed (e.g., due to network issues or some other errors).

Thus embodiments may leverage the folder capabilities of a management system to manage edge compute nodes, automatically synchronizing the node and folder relationships between components in real time, as well as enabling manual synchronization when needed.

FIG. 2 illustrates an example architecture including a central HCI management system 210 and one or more local HCI management systems 220, which may be located at a satellite cluster.

The central HCI management system 210 may provide various folders as shown, and hosts (e.g., HCI nodes) may be assigned to the folders. As denoted by the (M), Folders A, B, and E are currently managed by local HCI management system 220, and they may include one or more custom attributes. The custom attributes become associated with any hosts that are members of those respective folders.

When a user moves a host from one folder to another, the central and local HCI management systems 210 and 220 may need to keep track of the folder membership relations.

For example, suppose that an administrator moves Host A from managed Folder A to managed Folder E. PropertyCollectorService 222 of local HCI management system 220 may be notified regarding the change, and it may transmit a host movement event to moved hosts 224, which may comprise a list, a set, a queue, and/or any other suitable data structure for keeping track of hosts that have been moved.

Host movement listener 226 may retrieve the information from moved hosts 224 and push an event to the host movement handler 228. Host movement handler 228 may then calculate the movement and update the custom attributes for Host A accordingly (e.g., by changing Host A's folder attribute from Folder A to Folder E and updating any other custom attributes).

As another example, suppose that the administrator moves Host A from managed Folder A to unmanaged Folder D. PropertyCollectorService 222 may be notified regarding the change, and it may transmit a host movement event to moved hosts 224. Host movement listener 226 may retrieve the information from moved hosts 224 and push an event to the host movement handler 228. Host movement handler 228 may then calculate the movement and determine that Folder D is an unmanaged folder.

Host movement handler 228 may then save the host information into moved out hosts 232, which may comprise a list, a set, a queue, and/or any other suitable data structure for keeping track of hosts that have been moved of a managed folder. The GUI 234 may then retrieve information regarding the moved-out hosts for future processing.

In some embodiments, this architecture may also provide the capability to fully synchronize any drifted folder state by manually calling the host movement retriever 230. Host movement retriever 230 may find the moved hosts and send events to the moved hosts 224. Once moved hosts 224 receives the events, normal processing may resume as above.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
maintain a plurality of folders in a central management system, wherein each folder is a data structure having one or more hosts associated therewith; and
in response to an instruction to move a particular host from a first folder to a second folder:
un-associate the particular host from the first folder;
associate the particular host with the second folder; and
transmit a notification regarding the movement to a local management system of a satellite information handling system;
wherein the local management system is configured to update a local data structure regarding the movement.

2. The information handling system of claim 1, wherein the central management system is a central hyper-converged infrastructure (HCI) management system.

3. The information handling system of claim 1, wherein the particular host is a node of an HCI system managed by the central HCI management system.

4. The information handling system of claim 1, further configured to receive an instruction to perform a manual synchronization with the local management system.

5. The information handling system of claim 1, wherein the second folder is a managed folder that is managed by the local management system.

6. The information handling system of claim 1, wherein the second folder is an unmanaged folder.

7. A method comprising:
an information handling system maintaining a plurality of folders in a central management system, wherein each folder is a data structure having one or more hosts associated therewith; and
in response to an instruction to move a particular host from a first folder to a second folder, the information handling system:
un-associating the particular host from the first folder;
associating the particular host with the second folder; and
transmitting a notification regarding the movement to a local management system of a satellite information handling system;
wherein the local management system is configured to update a local data structure regarding the movement.

8. The method of claim 7, wherein the central management system is a central hyper-converged infrastructure (HCI) management system.

9. The method of claim 7, wherein the particular host is a node of an HCI system managed by the central HCI management system.

10. The method of claim 7, further comprising receiving an instruction to perform a manual synchronization with the local management system.

11. The method of claim 7, wherein the second folder is a managed folder that is managed by the local management system.

12. The method of claim 7, wherein the second folder is an unmanaged folder.

13. An article of manufacture comprising a non-transitory, computer-readable medium having computer-executable instructions thereon that are executable by a processor of an information handling system for:
maintaining a plurality of folders in a central management system, wherein each folder is a data structure having one or more hosts associated therewith; and
in response to an instruction to move a particular host from a first folder to a second folder:
un-associating the particular host from the first folder;
associating the particular host with the second folder; and
transmitting a notification regarding the movement to a local management system of a satellite information handling system;
wherein the local management system is configured to update a local data structure regarding the movement.

14. The article of claim 13, wherein the central management system is a central hyper-converged infrastructure (HCI) management system.

15. The article of claim 13, wherein the particular host is a node of an HCI system managed by the central HCI management system.

16. The article of claim 13, wherein the instructions are further executable for receiving an instruction to perform a manual synchronization with the local management system.

17. The article of claim 13, wherein the second folder is a managed folder that is managed by the local management system.

18. The article of claim 13, wherein the second folder is an unmanaged folder.
